(19) United States
(12) Patent Application Publication
(10) Pub. No.: US 2026/0166460 A1
(43) Pub. Date: Jun. 18, 2026

(54) CLEAN AIR EQUIPMENT

(71) Applicant: Hitachi Industrial Equipment Systems Co., Ltd., Tokyo (JP)

(72) Inventor: Takeshi KANEKO, Tokyo (JP)

(21) Appl. No.: 19/221,601

(22) Filed: May 29, 2025

(30) Foreign Application Priority Data
Dec. 13, 2024 (JP) 2024-218861

(51) Int. Cl. B01D 46/00; B01D 46/44

(52) U.S. Cl. CPC B01D 46/0086; B01D 46/446; B01D 2273/30; B01D 2279/51

(57) ABSTRACT

A clean air equipment that has a method for determining filter clogging that is both accurate and cost-effective. A clean air equipment having a filter, a wind speed sensor that measures the air speed after passing through the filter, a differential pressure sensor that measures the pressure difference before and after the filter, forming the second life prediction line so as to fit a changing rate of the first life prediction line obtained from the initial value of either one of the wind speed sensor or the differential pressure sensor and the value at the time of correction measurement with a changing rate of the second life prediction line obtained from another one of the wind speed sensor or the differential pressure sensor, managing the filter based on the first life prediction line or the second life prediction line.

### CROSS-REFERENCE TO RELATED APPLICATION

The present application claims priority from Japanese application JP2024-218861, filed on Dec. 13, 2024, the content of which is hereby incorporated by reference into this application.

### BACKGROUND OF THE INVENTION

### 1. Field of the Invention

The present invention relates to a clean air equipment.

### 2. Description of Related Art

The clean air equipment has various forms such as a safety cabinet, an FFU (fan filter unit), an air shower equipment, and the like, but all equipments having an air purification function.

As an example of the safety cabinet, there is JP2006-122816A. JP2006-122816A discloses a configuration in which it passes through the exhaust filter 18 and is exhausted from the duct 20 to the outside as clean air.

### SUMMARY OF THE INVENTION

The filter, over time of use, gradually develops clogging. Therefore, it is necessary to detect a decrease in the purification performance of the filter and replace it at any stage.

JP2006-122816A does not disclose such contents related to the determination of filter replacement.

One method of determining the replacement of the filter is a method of providing a differential pressure sensor that measures the differential pressure on the input side and the output side of the filter. It is a method of determining that if the differential pressure increases, the clogging of the filter has progressed. Further, there is a method of providing a wind speed sensor on the output side of the filter. If the wind speed decreases, it is a method that judges that the clogging has progressed.

However, in the case of a method using a differential pressure sensor or a method using a wind speed sensor alone, the error is large due to variations in the sensor and the like. In terms of accuracy, differential pressure sensors are those with excellent accuracy. However, since the air volume is not directly indicated, there is a problem that it cannot be applied directly to the final control index.

On the other hand, wind speed sensors can be applied to final control indicators, but there is a problem that they are inferior in accuracy. For this reason, in order to ensure the performance of the filter, it is necessary to replace the filter as soon as possible, and there is a problem that the frequency of filter replacement and the filter cost increase.

For this reason, it has been difficult to achieve both accuracy and cost.

Therefore, an object of the present invention is to provide a clean air equipment having a method for determining filter clogging that is both accurate and costly.

An example for solving the above problem is as follows.

A clean air equipment having a filter, with a wind speed sensor that measures the air speed after passing through the filter, a differential pressure sensor that measures the pressure difference before and after the filter, forming the second life prediction line so as to fit a changing rate of the first life prediction line obtained from the initial value of either one of the wind speed sensor or the differential pressure sensor and the value at the time of correction measurement with a changing rate of the second life prediction line obtained from another one of the wind speed sensor or the differential pressure sensor, managing the filter based on the first life prediction line or the second life prediction line.

According to the present invention, it is possible to provide a clean air equipment having a method for determining filter clogging that is both accurate and costly.

Further composition and effect of the present invention will be clarified through the full text of the specification below.

### BRIEF DESCRIPTION OF THE DRAWINGS

FIG. 1 is an example of a configuration diagram of the present invention.

FIG. 2 is the front view of the safety cabinet.

FIG. 3 is the side view of the safety cabinet.

FIG. 4 is a schematic explanatory diagram of the B-B cross-section of FIG. 3.

FIG. 5 is a schematic explanatory diagram of the A-A cross-section of FIG. 2.

FIG. 6 is an example of a characteristic diagram of a wind speed sensor.

FIG. 7 is an example of a characteristic diagram of a differential pressure sensor.

FIG. 8A is the transition of the time passage and output of the differential pressure sensor.

FIG. 8B is the transition of the time passage and output of the wind speed sensor.

FIG. 8C is the transition of the time passage and output of the differential pressure sensor and the wind speed sensor.

FIG. 8D is the transition of the time passage and output of the differential pressure sensor and the wind speed sensor after correction.

FIG. 8E is an explanatory diagram of the warning value W.

FIG. 8F is an explanatory diagram of the warning value E.

FIG. 8G is an explanatory diagram of the warning value W and E.

FIG. 8H is an explanatory diagram of an anomaly data.

FIG. 9A is an explanatory diagram of an example of process flow.

FIG. 9B is an explanatory diagram of an example of process flow.

FIG. 10A is an explanatory diagram of an example of process flow.

FIG. 10B is an explanatory diagram of an example of process flow.

FIG. 11A is an explanatory diagram of an example of sensor data processing.

FIG. 11B is an explanatory diagram of an example of sensor data processing.

FIG. 12A is an example of a screen display.

FIG. 12B is an example of a screen display.

FIG. 12C is an example of a screen display.

FIG. 12D is an example of a screen display.

FIG. 12E is an example of a screen display.

FIG. 12F is an example of a screen display.

FIG. 12G is an example of a screen display.

FIG. 12H is an example of a screen display.

FIG. 13 is an explanatory diagram of an example of data processing.

### DESCRIPTION OF EMBODIMENTS

Hereinafter, embodiments of the present invention will be described with reference to drawings as necessary.

### First Embodiment

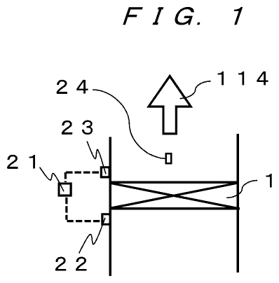

FIG. 1 is an example of a configuration diagram of the present invention. Clean air equipment have a filter 1. As shown in the air flow 114, it will be described in the case where air flows through the filter from the bottom to the top in the figure.

The differential pressure sensor 21 measures the differential pressure, which is the difference between the pressure of the primary pressure port 22 and the secondary pressure port 23. As the clogging of filter 1 progresses, the differential pressure measured by the differential pressure sensor 21 or the output value from the differential pressure sensor 21 increases.

A wind speed sensor 24 is used in addition to the differential pressure sensor 21. In the present invention, both the data of the differential pressure sensor 21 and the data of the wind speed sensor 24 are used to determine the clogging of the filter with both accuracy and cost.

Therefore, various clean air equipment having the configuration of FIG. 1, such as safety cabinets, air shower equipment, equipment FFUs, ceiling mounted FFUs, and the like are mainly applied.

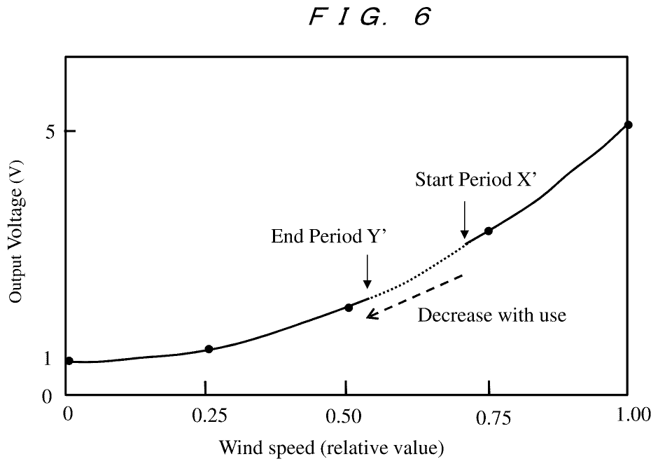

A specific method utilizing both the data of the differential pressure sensor 21 and the data of the wind speed sensor 24 will be described later with reference to FIGS. 6 to 8.

Next, an example of the structure of a safety cabinet will be described as an example of clean air equipment.

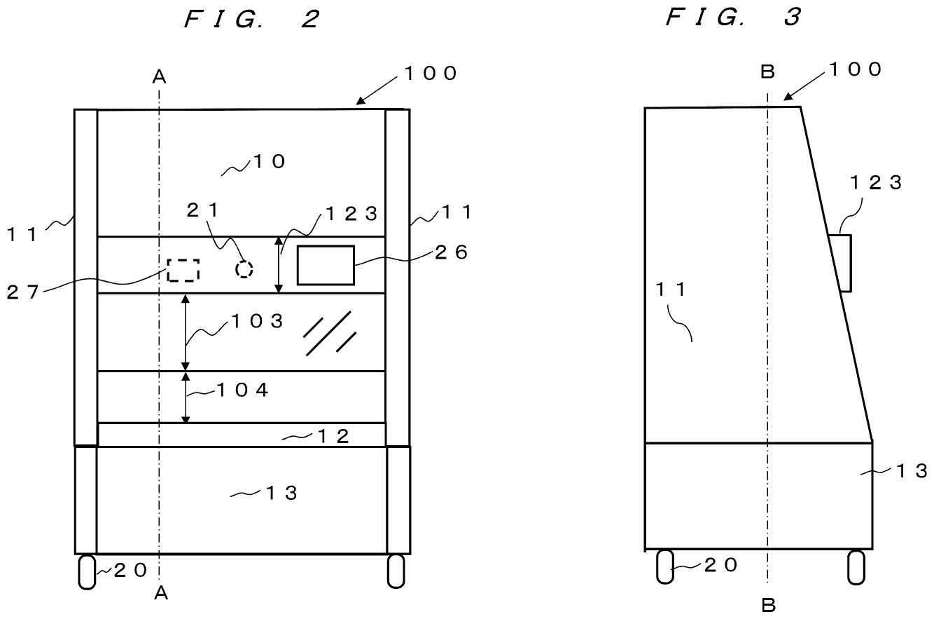

FIG. 2 is a front view of the safety cabinet of the present invention. Safety cabinets 100 is, for example, have a top housing 10, side housing 11, front housing 12, bottom housing 13, and legs 20.

Decorative cover 123 have an internal collection of illumination lights and control electrical components, and equipped with a differential pressure sensor 21, a programmable display 26, and a PLC (programmable logic controller) 27, which are features of the present invention.

The front shutter 103 made of transparent glass moves up and down the back side of the decorative cover.

Work opening 104 defined as a space between the front housing 12 and the lower surface of the front shutter 103.

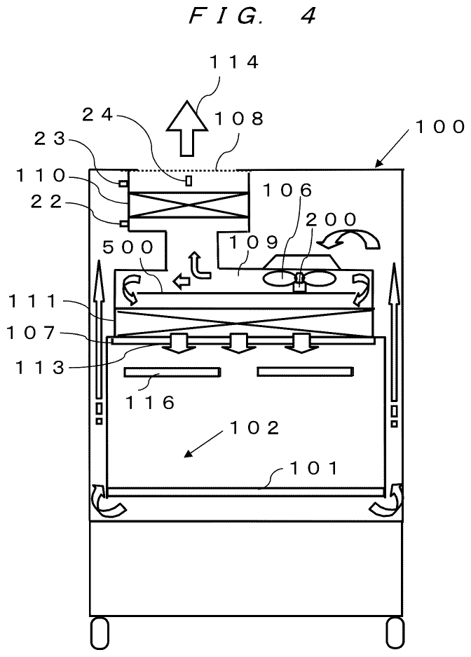

FIG. 3 is the side view of the safety cabinet. Safety cabinets 100 is, for example, have a side housing 11, bottom housing 13, and legs 20. And showing decorative cover 123.

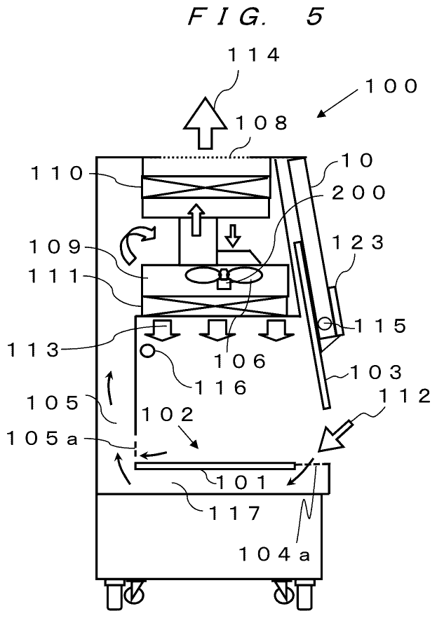

FIG. 4 is a schematic explanatory diagram of the B-B cross-section of FIG. 3. FIG. 5 is a schematic explanatory diagram of the A-A cross-section of FIG. 2. For the purpose of explanation, these figures omit details and simultaneously expresses members that are in a position that is out of alignment with that part.

The safety cabinet 100 has a work space 102 composed of a front shutter 103 inside. The lower surface of the work space 102 includes a work table 101, and a front slit 104a is disposed on the front shutter 103 side of the work table 101. Below the front shutter 103 forms a working opening 104. When the air supply fan 106 of the safety cabinet is operated, the upper chamber 109 is pressurized. A blowout HEPA filter 111 is connected to the upper chamber 109, and dust in the upper chamber 109 is filtered by the blowing HEPA filter 111, purified air is blown out, and after rectification with the blowout rectifier plate 107, it is supplied as a blowout airflow 113 in the work space 102.

An exhaust HEPA filter 110 is also connected to the upper chamber 109. The air from the charge air fan 106 is filtered with an exhaust HEPA filter 110. Thereafter, it passes through exhaust port 108 of the safety cabinet and is exhausted from the safety cabinet 100 as an air flow 114. Then, an amount of air equal to the air exhausted from the safety cabinet 100 enters the safety cabinet 100. The air is an incoming airflow 112 drawn from the working opening 104 below the front shutter 103. The inflow 112 is sucked into the front slit 104a together with a portion of the blowing airflow 113 of the working space 102. This air passes through the exhaust circulation path 117 below the worktable 101 and is sucked in from the rear slit 105a formed on the opposite surface of the front shutter 103 of the work space 102 along with a part of the blowout airflow 113, passes through the back path 105, and is sucked into the supply air fan 106 of the safety cabinet. As a result, the inflow 112 from the work opening 104 is all sucked into the front slit 104a and discharged, so that it does not flow into the work space 102 and serves as an air barrier for the inflow 112 from the work opening 104. 105a is a rear slit and 115 is a panel light.

In the work space 102, as an example of the use of a safety cabinet and the purpose, infectious substances such as pathogens and aerosols may be handled. In such a case, the dorsal path 105 and the upper chamber 109 also contain infectious substances and aerosols containing pathogens and the like. When supplying air to the workspace 102 and exhausting air from the safety cabinet 100, the infectious substance and aerosol are removed by the blowing HEPA filter 111 and the exhaust HEPA filter 110.

The operator sits in front of the safety cabinet 100, inserts an arm from the work opening 104 into the work space 102, and performs work while looking into the work space 102 through the front shutter 103. At this time, brightness is ensured by irradiating the work space 102 with illumination by illumination with the illumination lamp 115. In such a safety cabinet, the operator uses the front shutter with an opening specified by the manufacturer, for example, a 200 mm opening.

When the work is completed, the work table 101 is wiped clean with disinfectant ethanol or the like, the front shutter 103 is closed, the germicidal lamp 116 is lit for a certain period of time, and the surface of the work table 101 is sterilized.

As described above, in the safety cabinet 100, an air barrier that is an inflow flow 112 is important to ensure the safety of workers, so that infectious substances such as pathogens and aerosols handled in the work space 102 are leaked out of the safety cabinet 100 and infected to prevent people from being infected. In order to maintain the air barrier, it is important that the inflow 112 and the blowout airflow 113 of the safety cabinet 100 continue to maintain the defined wind speed range.

Therefore, in the present invention, it is possible to monitor a decrease in wind speed due to clogging of the HEPA filter, which differs depending on the usage environment and usage conditions, by a plurality of state monitoring, and to improve the life prediction accuracy of the HEPA filter.

Here, the roles of the wind speed sensor 24 and the pressure ports 22 and 23 shown in FIG.

As described above, an amount of air equal to the air flow 114 flows into the safety cabinet 100 as the incoming air flow 112 and plays the role of an air barrier. Therefore, in order to secure the air barrier, it is sufficient to maintain the air flow 114 within a specified range. Therefore, the air speed sensor 24 is disposed at a position where the air pushed out by the supply air fan 106 detects the clean air after passing through the exhaust HEPA filter 110, and the exhaust air speed is detected. This is because it is better to pass through clean air in order to prevent false detection due to contamination of the wind speed detection part of the wind speed sensor. The wind speed sensor uses an electrical output signal function, and for example, there is a type in which the output voltage changes according to the wind speed change.

To confirm the wind speed performance of the safety cabinet 100, an anemometer specified in the Class 2 cabinet for JIS_K_3800 measures against biohazards is used, and the microanemometer specified in the JIS_T_8202 is ±0.015 m/s when the indicated value is 0.5 m/s or less, and ±3% in the range where the indicated value exceeds 0.5 m/s. It is used for factory inspections and periodic inspections of safety cabinets. On the other hand, an anemometer with this accuracy is expensive, and it is not suitable to equip it in the safety cabinet itself for the purpose of constantly monitoring the wind speed of the safety cabinet.

Therefore, for the purpose of constantly monitoring wind speed by equipping it in a safety cabinet, although the absolute accuracy does not meet the above, the accuracy of reproducibility (repetition characteristics) is higher than the above accuracy. By the above combination, it can be possible to decrease cost and ensure the necessary accuracy.

Further, the conditions under which the wind speed decreases include not only clogging of the HEPA filter, but also abnormalities in fan control components such as the supply air fan 106 and the inverter, contamination of foreign matter in the exhaust HEPA filter and the supply air fan 106, and various conditions such as blocking the air flow of the work space 102 by installing a large experimental device on the work table 101, and blocking the exhaust port 108. Therefore, in order to measure the differential pressure upstream and downstream pressure of the exhaust HEPA filter 110 equipped with a differential pressure sensor 21, a primary pressure port 22 and a secondary pressure port 23 are installed. It is connected to the high-pressure side or the low-pressure side of the piping connection port of the differential pressure sensor 21 with a vinyl tube or the like, and the differential pressure upstream and downstream of the exhaust HEPA filter 110 is monitored.

As a result, it can be determined that the exhaust HEPA filter 110 is clogged only when the wind speed passing through the exhaust HEPA filter 110 decreases and the differential pressure between upstream and downstream of the exhaust HEPA filter 110 increases.

FIG. 6 shows an example of a characteristic diagram of the wind speed sensor 24. The wind speed sensor 24 has the characteristic that the output voltage changes with the change in the wind speed. The horizontal axis is the relative value of wind speed. When the wind speed decreases due to clogging of the filter with use from the start period X′ to the end period Y′, the output voltage from the wind speed sensor 24 decreases.

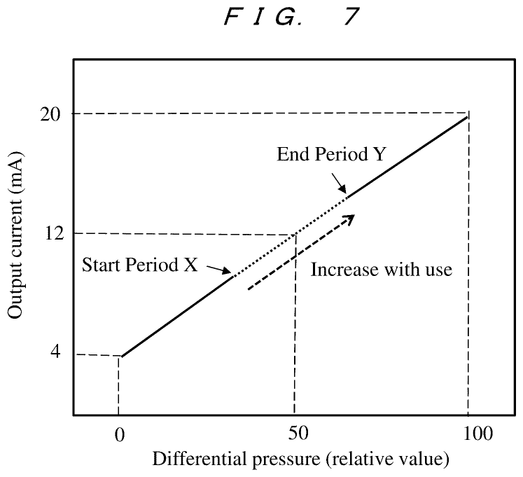

FIG. 7 shows an example of a characteristic diagram of the differential pressure sensor 21. The differential pressure sensor 21 has the characteristic that the output current changes with the change in the differential pressure. The horizontal axis is the relative value of the differential pressure. The differential pressure sensor 21 detects the differential pressure between the primary side, which is the upstream side, and the secondary side, which is the downstream side, of the exhaust HEPA filter 110.

Therefore, when the differential pressure increases due to clogging of the filter with use from the start period X to the end period Y, the output current from the differential pressure sensor 21 increases.

In addition, wind speed sensors and differential pressure sensors having such characteristics are widely commercially available.

With the passage of the operation time of the clean air device, dust collection by the exhaust HEPA filter 110 proceeds. As a result, the air resistance of the exhaust HEPA filter 110 increases, and the differential pressure increases. At the same time, this means that the wind speed decreases.

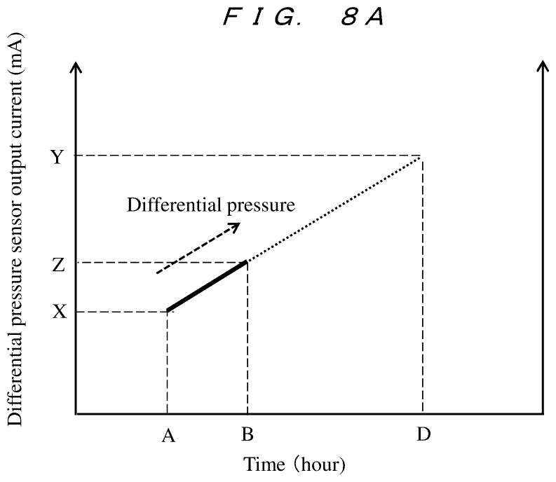

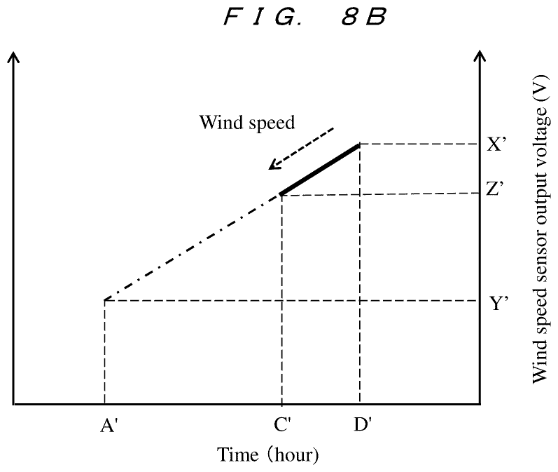

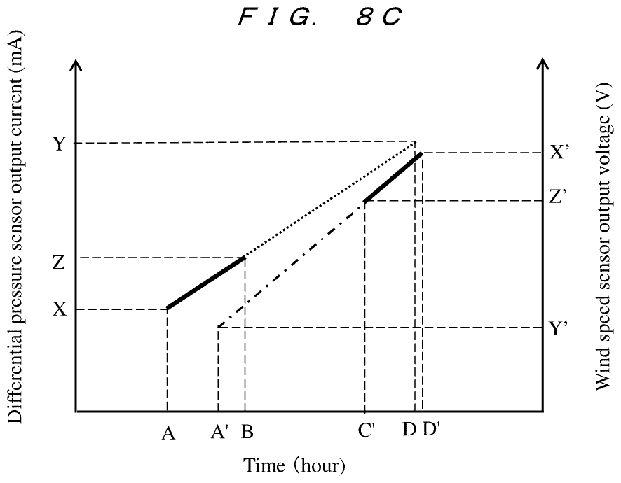

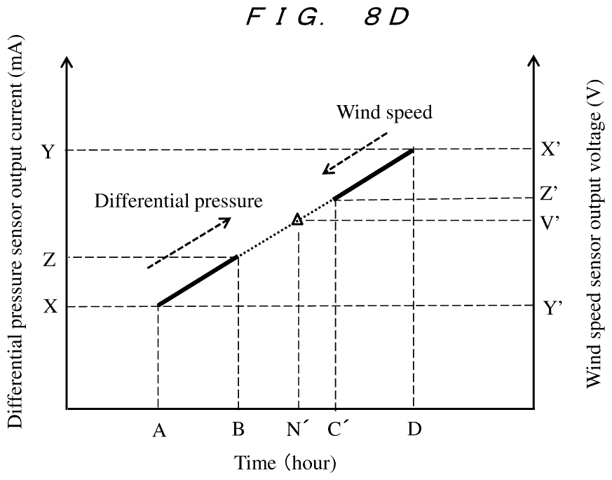

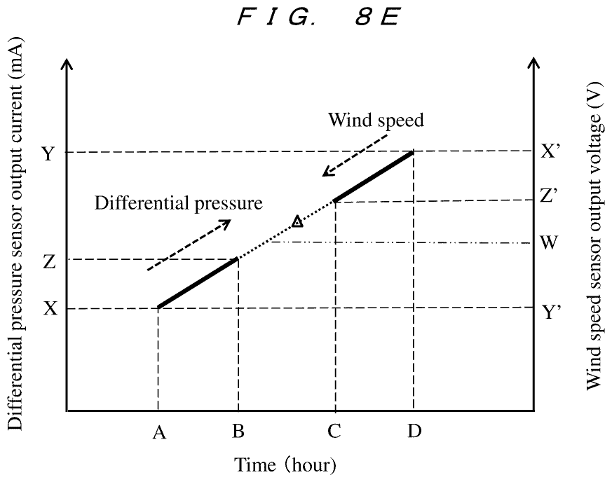

Hereinafter, using FIGS. 8A to 8D, a method for determining filter clogging that achieves both accuracy and cost by correcting so as to correlate the output current of the differential pressure sensor and the output voltage of the wind speed sensor will be described. In the following, a case where a life prediction line of a wind speed sensor is created using a life prediction line having a positive value of the differential pressure sensor will be described as an example.

FIG. 8A is a diagram showing the time lapse of the output of the differential pressure sensor. The horizontal axis is time. With the passage of time of use, clogging of the filter progresses and the differential pressure increases. As shown in the figure, it is detected in the form of an increase in the output current of the differential pressure sensor on the vertical axis.

The start period is time A, and the output current of the differential pressure sensor is X. The end period that serves as the life of the filter is time D, and the output current of the differential pressure sensor is Y. Y is the predicted calculated value. At the time of the first inspection or correction inspection, the time B is and the output current of the differential pressure sensor is Z. FIG. 8A can also be referred to as the life prediction line or the first life prediction line of the differential pressure sensor.

FIG. 8B is a diagram showing the time lapse of the output of the wind speed sensor. The horizontal axis is time. Over time of use, clogging of the filter progresses and the wind speed decreases. As shown in the figure, it is detected in the form of a decrease in the output voltage of the wind speed sensor on the vertical axis.

The start period is time D′, and the output voltage of the wind speed sensor is X′. The end period of the life of the filter is time A′, and the output voltage of the wind speed sensor is Y′. Y′ is the predicted calculated value.

FIG. 8B can also be referred to as the life prediction line of the wind speed sensor or a second life prediction line.

FIG. 8C is a diagram in which FIGS. 8A and 8B are superimposed and expressed in one figure. The graph of the output current of the differential pressure sensor and the graph of the output voltage of the wind speed sensor differ in slope and magnitude, and at this stage they remain separate information.

Therefore, the inventors have considered providing clean air equipment having a method for determining filter clogging that is both accurate and costly by correcting so as to correlate the output current of the differential pressure sensor and the output voltage of the wind speed sensor.

FIG. 8D is a graph after correcting FIG. 8C to have a correlation between the output current of the differential pressure sensor and the output voltage of the wind speed sensor.

An example of the correction method is to match the slope of the output voltage of the wind speed sensor to the slope of the output current of the differential pressure sensor in FIG. 8C. And to match A and A', and to match D and D′.

FIG. 8D can also be referred to as a corrected life prediction line.

As a result, as shown in FIG. 8D, A and A′ coincide, and D and D′ coincide. Also, the length between X and Z and the length between X′ and Z′ also coincide. Thereby, it is possible to express the time course of the output current of the differential pressure sensor and the time course of the output voltage of the wind speed sensor in the same linear shape.

Note that Z′ is the wind speed sensor output voltage when a predetermined elapsed time has elapsed from D (time between D and C). Here, the predetermined elapsed time is equal to a predetermined elapsed time (time between A and B).

As a result, as described above, by creating a life prediction line of the wind speed sensor using a life prediction line having the average value of the differential pressure sensor positive, it is possible to provide a clean air device having a method for determining filter clogging that is both accurate and cost. If you use speed sensor with excellent accuracy, it will be expensive, so even if you use an inexpensive one, it is possible to provide clean air equipment having a method for determining filter clogging that is both accurate and costly.

Additionally, as a further improvement of the accuracy of the wind speed sensor, when measuring X′, the wind speed is measured with an expensive and high-precision anemometer installed only at that time from the outside, and the output voltage of the wind speed sensor is multiplied by a correction factor or added according to the result. This is because it can be expected to improve accuracy.

In FIG. 8D, the thick line related to the differential pressure sensor output current is a line connecting the initial value of the differential pressure and the time of the first inspection or the time of correction inspection. The thick line related to the wind speed sensor output voltage is a line connecting the initial value of the wind speed and the time of correction inspection. The triangle in the figure is the output voltage V′ of the wind speed sensor at the time when the time has elapsed from the initial D to an arbitrary measurement time N′. Then, by performing correction, it is possible to accurately judge the change in wind speed by applying the value of V′ to the graph of the wind speed sensor output voltage and wind speed in FIG. 6.

Fundamentally, if an ultra-expensive and ultra-high-precision wind speed sensor is used from the beginning as the wind speed sensor, such a correction process is not necessary. However, for products that are premised on mass production, such as ordinary industrial applications, there is a limit to the cost of parts that can be spent, and it is difficult to adopt high-performance products without looking at the cost degree. Therefore, the problem of the accuracy of the parts themselves and the variation between parts is unavoidable. In this case, the method of correction can realize substantial improvement in accuracy and suppression of the effects of variation, so it is a technical concept that has a large effect of improving the performance of actual mass-produced products.

FIG. 8E is an example in which the first warning value W is introduced. When the output voltage V′ of the wind speed sensor, which is a triangle in the figure, exceeds the first warning value W, it can still be judged that the degree of clogging progress of the filter is minor. For example, at the next periodic inspection, it will be possible to omit the precise measurement of wind speed by workers at the site. It is possible to save labor in periodic inspection work and to abbreviate it as a remote inspection.

Further, when the output voltage V′ of the wind speed sensor, which is a triangle in the figure, is lower than the first warning value W, it is judged that the clogging of the filter is progressing to some extent. By outputting advance cautionary information, the user of the device can proceed in advance with budget measures for ordering filter replacement parts.

FIG. 8F is an example in which a parts replacement warning value E is introduced. It may be referred to as the second warning value. When the output voltage V′ of the wind speed sensor, which is a triangle in the figure, is lower than the component replacement warning value E, it is determined that the filter replacement is desirable due to the clogging progress of the filter, or that the filter replacement will soon reach a desirable state. It then raises an alarm and prompts the user to arrange or order a replacement filter.

FIG. 8G is a diagram in which FIGS. 8E and 8F are displayed together, and the relationship between W and E is shown. E is set lower than W, and the time axis is set to the left, indicating that it is set to a stage where the filter usage time has elapsed.

It is desirable that W and E are also corrected at the time of correction according to FIGS. 8C to 8D.

In FIGS. 8E to 8F, an example of setting the first warning value W and the parts replacement warning value E as the life prediction line of the wind speed sensor and outputting a warning or warning in advance is shown. The first warning value W or the parts replacement warning value E may be defined in the life prediction line of the wind pressure sensor, and a warning or warning may be output in advance. When judged by a sensor that has only the accuracy of reproducibility (repetition characteristics), it is not reliable as an absolute value, but it is reliable as a relative value. On the other hand, when judged by a sensor having the necessary absolute accuracy, although there is a variation in the parts, it is reliable as an absolute value, so both reproducibility and absolute value can be reliable regardless of which life prediction line is used, so it can be used for advance warnings and warnings.

FIG. 8H is a diagram illustrating an example of a situation at the time of irregularity. 25 is anomaly data, indicating a state in which it is temporarily detected and eventually disappears over time.

Such temporary anomaly data is judged to reflect the temporary usage status and installation state of the equipment, and it is judged that it is not an abnormality of the filter itself. Thereby, it is possible to avoid unnecessary filter replacement.

Alternatively, such anomaly data is detected between any of the output voltage of the wind speed sensor and the output current of the differential pressure sensor, or when there is a large difference in the degree of abnormality between the two, the abnormal data is detected, and before it disappears, it is determined that the use state or installation state of the device are inappropriate, and can suggest to the users to check the usage and installation conditions, and suggestions can be made to correct them.

Specifically, in the case of a safety cabinet, it is a case where too many items are arranged in the work chamber or an obstruction is installed on the exhaust path. In such a case, by confirming the usage status and installation status and proposing corrections to the user, the user can grasp the situation and take corrective measures. For this reason, it is possible to operate the clean air device in an appropriate state.

Note that each diagram of FIG. 8 can be referred to as an example of the life prediction characteristic diagram of the filter. Further, as described above, a case where a life prediction line of a wind speed sensor is created using a life prediction line having the value of the differential pressure sensor positive has been described as an example, but a life prediction line having the value of the wind speed sensor positive may be used to create a life prediction line of the wind pressure sensor.

In FIG. 8D, the wind speed sensor output voltage and the differential pressure sensor output current are represented by a single approximate straight line, or by performing a similar correction, it is possible to display a comparison of wind speed and pressure, and mutual output data is also monitored. Therefore, a failure or abnormality detection function of any sensor can also be realized.

As an example, the display of FIG. 8D is equipped with a device having a display function and an operation function such as a programmable display unit 26 and a PLC (programmable logic controller) 27 to configure a program. It is desirable to connect the electrical output signal cable of the differential pressure sensor 21 and the wind speed sensor 24 to the input terminal of the PLC 27 to suck up the output data and calculate it, and display FIG. 8D, which is the calculation result, on the programmable display 26.

As an example, the programmable display 26 may be placed in a decorative cover 123 or the like on the front of the safety cabinet 100 and placed in a position where the operator can always see it.

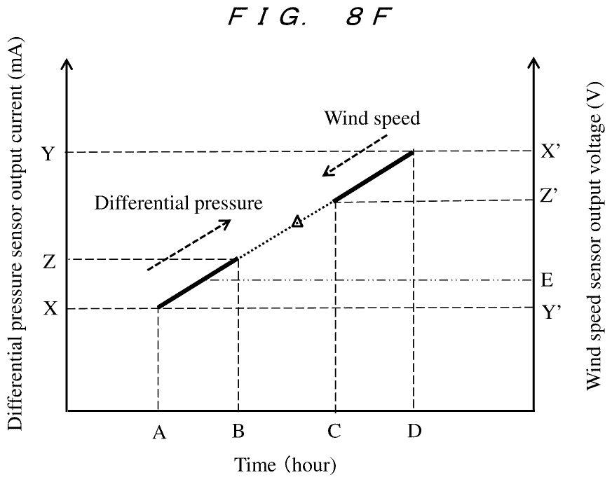

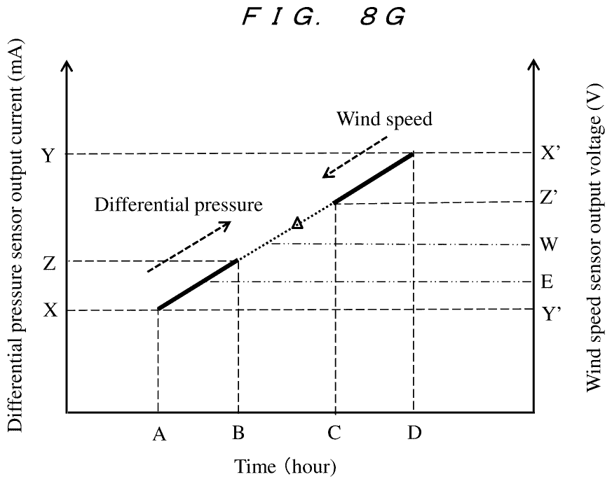

FIG. 9A is an example of the operation flow. Step S1 is an inspection during installation. The X′ of FIG. 8A and the X′ of FIG. 8B are measured. Step S2 is a correction measurement after the lapse of time. Z in FIG. 8A is measured. The timing of the correction measurement is performed at the time of the first inspection.

The life of the filter and the exhaust HEPA filter 110 is affected by the amount of dust and temperature and humidity in the installation environment, and the time of use. However, by creating a correction measurement after a certain amount of actual use has passed, such as performing at the time of the first inspection or at an appropriate time limit such as one year, a profile in the actual use environment will be created. For this reason, it is possible to improve the accuracy of the time when the wind speed is the lower limit of the specification value, which is the terminal Y′, and it is possible to achieve high accuracy of life prediction and life management.

Further, X′ may use the value of the wind speed sensor built-in in the device. However, by bringing in a high-precision wind speed measuring device from the outside and performing correction measurement on the wind speed sensor built into the device, a correction formula, a correction factor, an additional value, and the like that achieve higher accuracy may be derived and applied.

In addition, when bringing in a high-precision wind speed measurement device, the wind speed is measured with an anemometer specified in the class 2 cabinet for JIS_K_3800 biohazard countermeasures and the pressure value is plotted, and at the periodic inspection one year later, the wind speed is measured in the same way and the pressure value may be plotted.

In step S3, the life of the filter is predicted from the result of the correction measurement. Here, X′, D′, Y′, and A′ of FIG. 8B are derived. It is not excluded to predict only one of them and use the specified value for the other.

In step S4, the slope of the wind speed sensor output voltage and the differential pressure sensor output current is matched, and one end point is corrected so that the start point of the other is corrected. As a result, the life prediction characteristic diagram of the filter of FIG. 8D is completed.

Then, using the life prediction characteristic diagram of the filter or equivalent data, the status of the filter is managed in step S5. Note that even if they are not integrated as a graph as shown in FIG. 8D, if they are superimposed as shown in FIG. 8D, the wind speed sensor output voltage and the differential pressure sensor output current may be treated, processed, and judged separately.

In step S6, if the wind speed data has not decreased to the first warning value W, the clogging progress of the filter is insignificant, and wind speed measurement can be excluded at the next periodic inspection, for example. In this case, the time and efficiency of the periodic inspection work can be shortened. In addition, it will be possible to respond by remote inspection.

In step S7, when the wind speed data drops to the second warning value E, it is assumed that the clogging of the filter has progressed, for example, an alarm is fired, and a replacement filter is arranged, or a long delivery time part is ordered. In this way, parts can be arranged in advance. Then, in step S8, by replacing the parts at the next periodic inspection or the like, the operation downtime of the clean air device can be minimized.

For example, in the case of step S7, where parts are not arranged in advance and the filter life is confirmed for the first time by wind speed measurement at the time of periodic inspection, parts are arranged from there, replacement is carried out after obtaining parts, and depending on the type and situation of the filter, it may take several months to replace. In a worst-case scenario, the clean air system will be shut down for an extended period of time. As shown in FIG. 9B, in particular step S7, flow management so that parts can be ordered in advance can be performed to ensure that a long period of downtime of the clean air device is avoided and downtime can be minimized.

In addition, a profile in the actual use environment is created by creating a correction measurement after a certain amount of actual use has passed, such as performing a correction measurement at the time of the first inspection or at an appropriate deadline such as one year. As a result, if the time to the end period Y′ exceeds 1 year, wind speed measurement in the periodic inspection can be excluded. In addition, when the wind speed drops to the parts replacement warning value E, which is provided in consideration of the parts delivery date, it can be displayed on an alarm buzzer or a programmable display to encourage the ordering of parts. As a result, it is possible to replace parts as planned at the time of periodic inspection, and it is possible to measure the wind speed with the minimum necessary number of times, and the non-operating time of the safety cabinet 100 can be shortened, and productivity is improved.

Further, by using the data to compare data when handled in different environments and in different usage methods, it can be useful for work improvement and factor analysis of part deterioration.

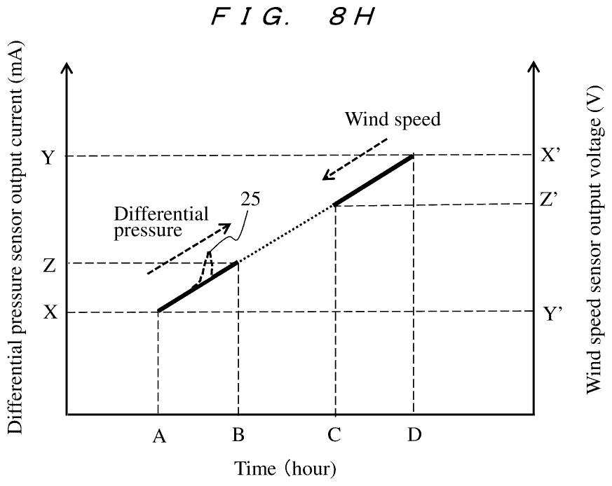

FIG. 10A is an example of an operation flow corresponding to FIG. 9B. It can also be said that it is a flow that is explained by changing the expression.

Step S11 is an installation inspection. X′ of FIG. 8B is measured. Step S12 is the first periodic inspection. Z′ in FIG. 8B is measured.

In step S13, the life of the filter is predicted from the operation status up to the first periodic inspection. This will result in the creation of a profile in a production environment.

In step S14, the slope is matched and corrected so that the end point of one is the start point of the other.

Steps S16 to Steps S18 are the same as steps S6 to S8, respectively.

FIG. 10B has a feature in step S15 with respect to FIG. 10A. It is more desirable that step S15 is always performed during steps S14 and later to steps S17 on the flow of FIG. 10B.

Step S15 is a step of notifying an alarm of caution when one deviates from the predicted value by a certain value or more. In FIG. 8H, it corresponds to the case where the anormaly data 25 is detected. In such a case, specifically, it is assumed that a large number of articles are arranged in the work chamber or that an obstruction is installed on the exhaust path. In such a case, by confirming the usage status and installation status and proposing corrections to the user, the user can grasp the situation and take corrective measures. For this reason, it is possible to operate the clean air device in an appropriate state.

### Second Embodiment

This embodiment is applied in combination with first embodiment.

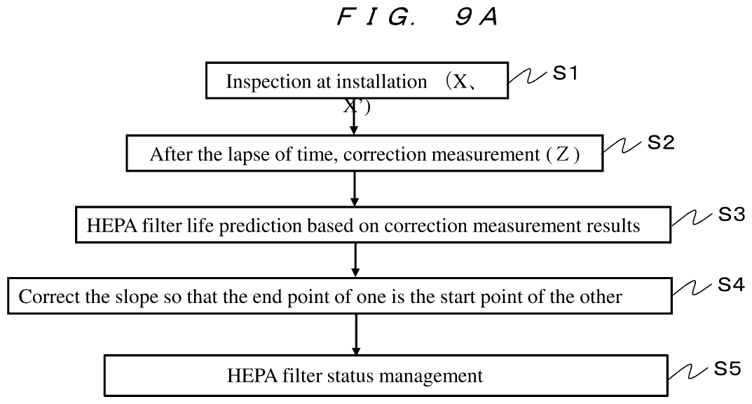

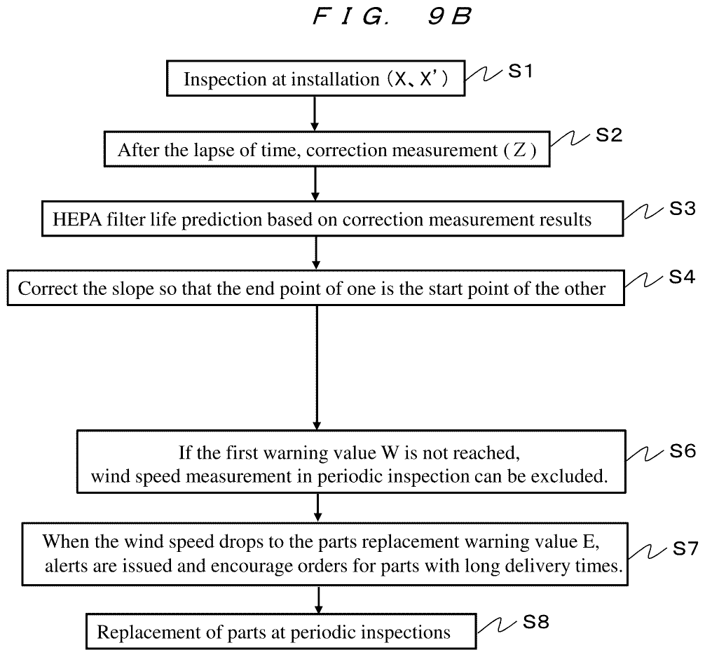

FIG. 11A shows an example of sensor data processing. The data of the differential pressure sensor 21 and the data of the wind speed sensor 24 are input to the PLC 27. The processing result and the determination result in the PLC 27 are displayed on the programmable display unit 26.

FIG. 11A is an example in which a PLC 27 and a programmable display 26 are mounted on the clean air device itself.

However, when the cleanliness is managed as a clean room in the safety cabinet 100 or the room in which the clean air device is installed, a control panel is provided in another place or the like, and an arithmetic device is installed therein, and the temperature and humidity of the clean room, the cleanliness, and the operating state of the equipment used may be recorded. In that case, the electrical output signal of the wind speed sensor or the differential pressure sensor may be connected to the arithmetic device, and the calculation result may be displayed on the recorder side or the calculation. In that case, the safety cabinet 100 and the clean air device do not require a programmable display or a PLC, and can be centrally managed by an arithmetic unit. Alternatively, judgment and processing may be performed by an arithmetic device while leaving one or both of the programmable display and PLC in the safety cabinet 100 or the clean air device.

FIG. 11B is an example in which the arithmetic device 301 is arranged via a communication line 300 or electrical wiring. The data of the differential pressure sensor 21 and the data of the wind speed sensor 24 are transmitted to the arithmetic unit 301 via the PLC 27 or directly as the collected data 310. The arithmetic device 301 includes various examples, such as when it is provided in a control panel, in a centralized control room, or when it is configured with a remote management server or a management cloud system.

The arithmetic unit 301 performs some or all of the processing as performed in each of the figures of FIG. 8 and the figures of FIGS. 9 and 10. The result of the operation is transmitted to the programmable display 26 as the processed data 311 and displayed. Of course, it may also be displayed on display means such as a control panel, a centralized control room, or a monitor provided in connection with a remote management server or a management cloud system.

### Third Embodiment

The present embodiment is applied in combination with at least one of first embodiment and second embodiment.

In this embodiment, an example of display on the programmable display unit 26 will be described. In addition, it also includes the case where it is displayed on display means such as a control panel, a centralized control room, or a monitor provided in connection with a remote management server or a management cloud system.

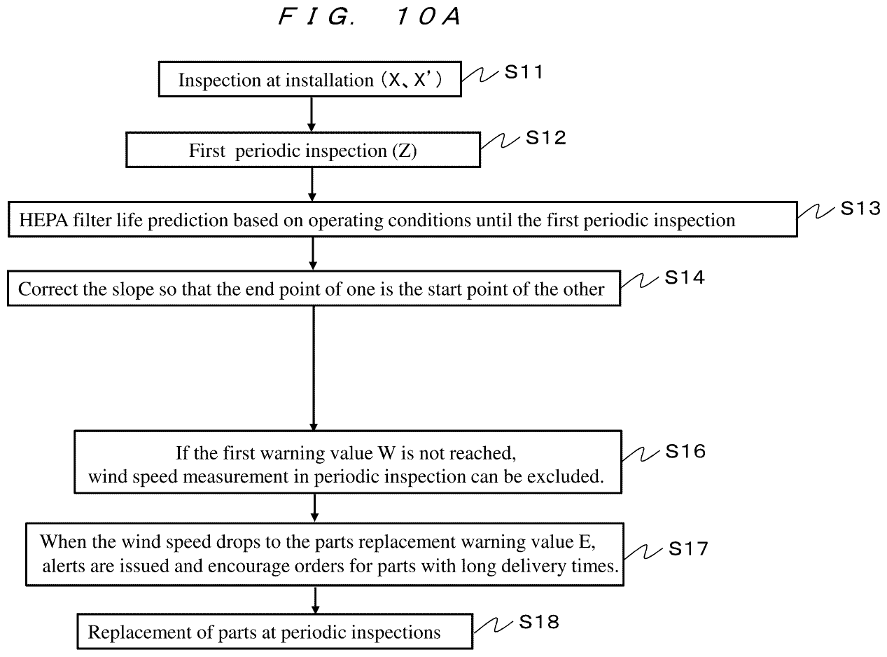

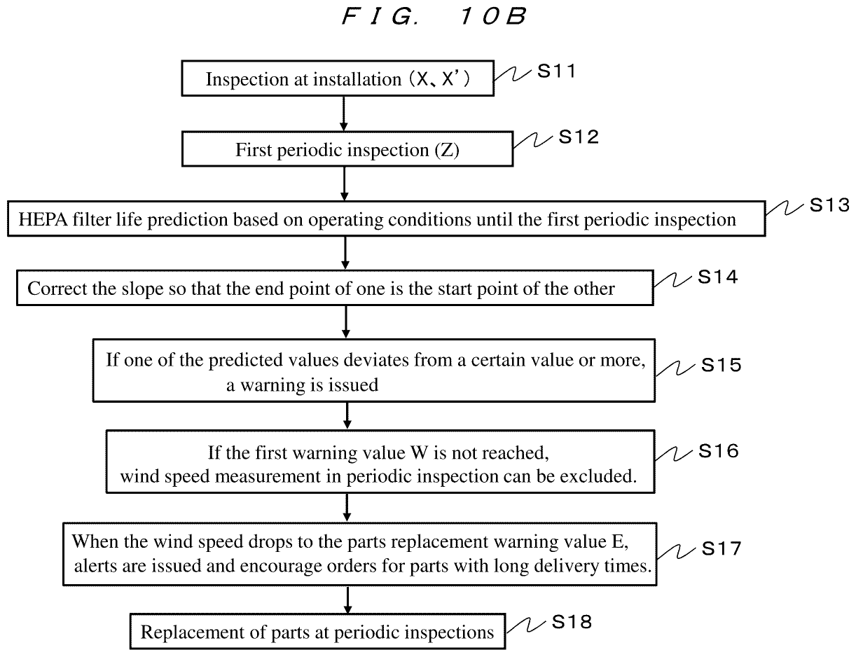

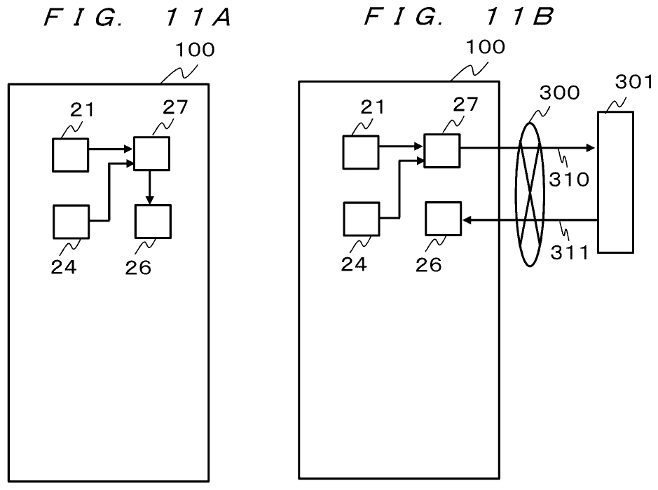

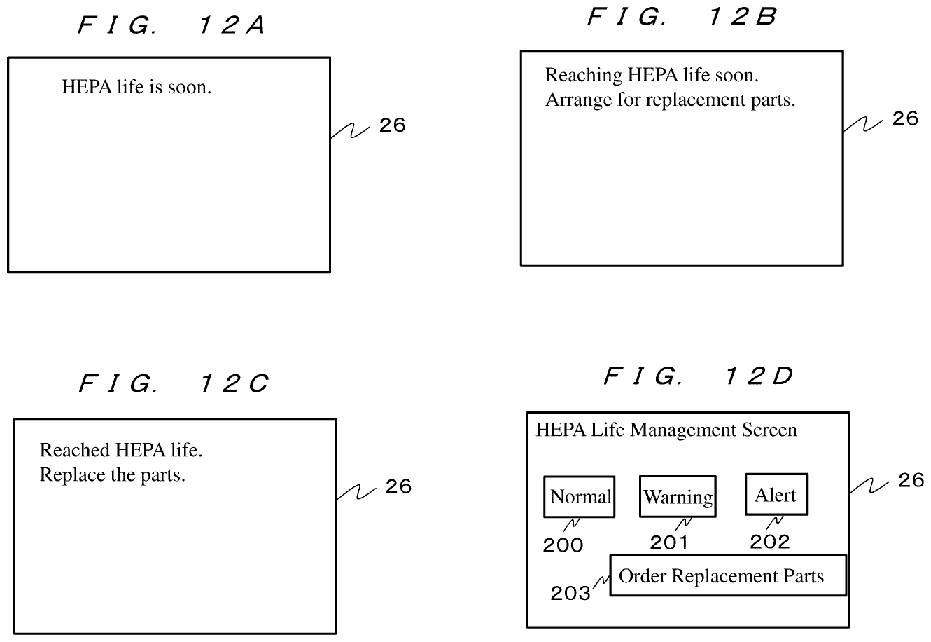

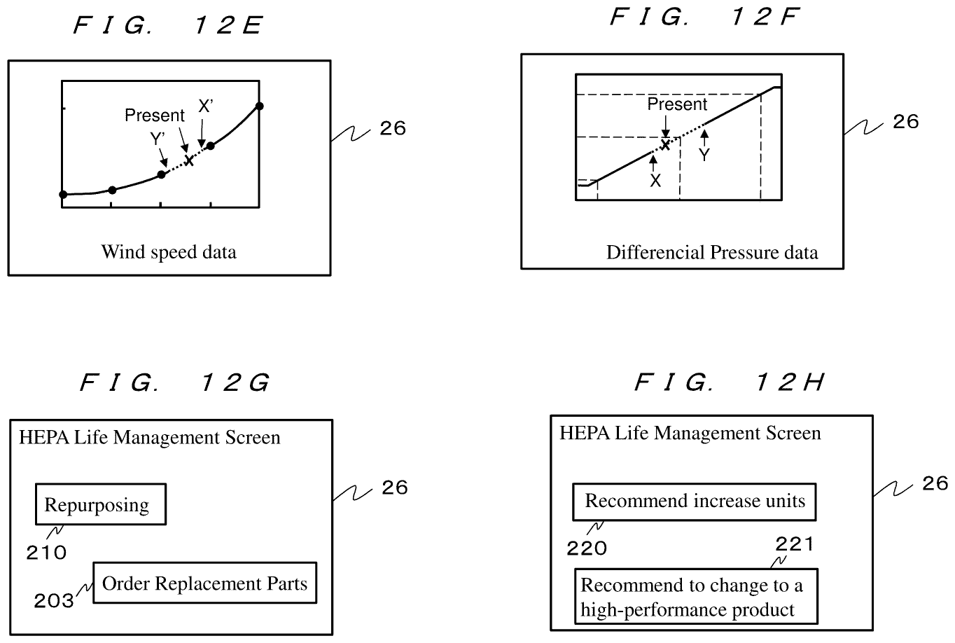

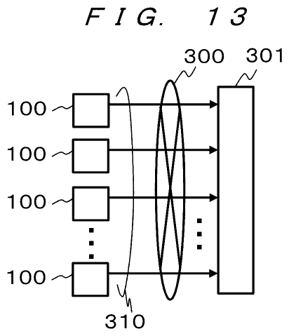

FIG. 12A is an example of a screen display. The indication is that the filter is nearing the end of its life. For example, it is a display example such as when the wind speed is lower than W in FIG. 8.

FIG. 12B is an example of a screen display. It indicates that the life of the filter is approaching the end of its life. Then, it is a display requesting the arrangement of replacement parts. For example, it is a display example such as when the wind speed reaches E in FIG. 8.

FIG. 12C is an example of a screen display. It is an indication that the life of the filter has been reached. It shows that the required performance cannot be achieved by using it as it is, and more directly requests for replacement of parts and filters. For example, it is a display example when the wind speed is lower than Y′ in FIG. 8.

FIG. 12D is an example of a screen display. This is an example of a case where the filter life management screen is provided as a screen configuration. The region 200 is normal, the region 201 is warning, the region 202 is an alarm, and the like is lit and displayed, so that the user can intuitively grasp the status of the filter. Area 203 is a replacement parts order button.

When the programmable display unit 26 is configured with a touch panel, it is a screen that allows the replacement filter to be ordered with one click by the user by touching the region 203 or by clicking it with a mouse operation on the monitor. Since the model number and information of the filter used in the clean air device are registered in advance in the clean air device and the calculation device, appropriate parts are delivered even if the order can be completed with one click. For example, when FIG. 12B is displayed, the user performs a screen operation to display the life management screen of FIG. 12D, and clicks the area 203 to arrange replacement parts without delay.

FIG. 12E is an example of a screen display. It is a display screen of wind speed data. FIG. 12E is an example in which a screen corresponding to FIG. 6 is displayed, but a screen corresponding to FIGS. 8C to 8G may also be displayed.

FIG. 12F is an example of a screen display. It is a display screen of differential pressure data. In FIG. 12F, it is an example in which a screen corresponding to FIG. 7 is displayed, but a screen corresponding to FIG. 8C to 8G may be displayed.

FIG. 12G is an example of a screen display. It is characterized in having a button for changing the use of the region 210.

When a large number of clean air devices, such as safety cabinets, are arranged in the same work area, each safety cabinet does not necessarily perform the same work, and some safety cabinets may be used less than actual work, such as advance preparation and reagent preparation. In such a case, by assigning the device with advanced filter clogging to such a work that has a smaller usage ratio than the actual work or does not have a high requirement for cleanliness, it is possible to postpone the time until the filter replacement of the device. Thereby, when a large number of clean air devices are present, it is possible to suppress operation stoppage.

In that case, it is desirable to proceed with the arrangement of replacement parts at the same time. Therefore, in FIG. 12G, the replacement parts order button of region 203 is also displayed.

Further, when the button of the region 210 is pressed, it is desirable to display that the use of the device is limited.

FIG. 12H is an example of a screen display. When the operating status of the apparatus is too high than expected or the clogging progress of the filter is too high than expected, a message to the effect that it is recommended to increase the number of units is displayed in the area 220, or a message to the effect that it is recommended to replace with a high-performance product is displayed in the area 221. Note that the message display area may be in a different position. If excessive operation exceeds the expected situation for a long period of time, as a result, there is a risk that the production process related to the use of clean air equipment will be inefficient and the actual operation rate will decrease due to an increase in the waiting time for work and an increase in the waiting time for cleaning. In such a case, by displaying a message in the area 220 to the effect that it is recommended to increase the number of units or a message in the area 221 that it is recommended to replace it with a high-performance product, the user can use it as an opportunity to build a more efficient production system.

### Forth Embodiment

The present embodiment is applied in combination with at least one of first embodiment to third embodiment.

FIG. 13 shows that the collected data 310 from the plurality of safety cabinets 100 is aggregated in the arithmetic unit 301. The safety cabinet 100 also includes the case of various clean air devices such as a safety cabinet, an air shower device, an FFU for the device, and an FFU for ceiling installation.

Based on the data collected in the arithmetic device 301, the supplier can place a bulk order, arrange a filter, or produce it together. Or, if you are a large user, you can place a bulk order or make a group arrangement. This makes it possible to avoid running out of stock of the filter. In some cases, it is also possible to reduce the purchase price of the filter by increasing the order quantity.

In addition, by managing the schedule of the next inspection and the corresponding filter replacement date and time based on the collected data, it is possible to eliminate the need to supplement the replacement filter excessively and optimize the number of inventory.

### Fifth Embodiment

The present embodiment is applied in combination with at least one of first embodiment to forth embodiment.

In addition, ceiling FFUs have different features from other clean air devices. It is characterized by the fact that a large number of FFUs of the same specification are arranged in the same space. For example, in a huge clean room such as a semiconductor factory, more than a few dozen ceiling FFUs are arranged across the ceiling of the same room.

In such a case, the progression of clogging of the filter of each ceiling FFU proceeds almost simultaneously

Therefore, when a large number of ceiling FFUs are disposed, at least one of the functions of embodiments 1 to 4 is installed only in a part thereof, and most of the other functions are not installed.

As an example, only one unit in the center of the room is equipped with a function, and the others are not. Or, from the idea of fail-safe, only multiple units are equipped with the function, and the majority of others are not installed.

In this embodiment, in addition to the effect of either embodiments 1 to 4, the ceiling FFU realizes a reduction in equipment cost without affecting performance.

As long as the ideas and concepts disclosed in the above descriptions are used, their variations and similar examples are also included in the scope of the present invention.

In the example of the safety cabinet, not only the case where the differential pressure sensor 21 and the wind speed sensor 24 are used for managing the exhaust HEPA filter 110, but also another differential pressure sensor 21 and the wind speed sensor 24 for managing the blowing HEPA filter 111. In that case, the life of the exhaust HEPA filter 110 and the blowing HEPA filter 111 can be managed separately.

In addition, examples of the present invention can be represented as follows.

### First Example

A clean air equipment having a filter, with a wind speed sensor that measures the air speed after passing through the filter, a differential pressure sensor that measures the pressure difference before and after the filter, forming the second life prediction line so as to fit a changing rate of the first life prediction line obtained from the initial value of either one of the wind speed sensor or the differential pressure sensor and the value at the time of correction measurement with a changing rate of the second life prediction line obtained from another one of the wind speed sensor or the differential pressure sensor, managing the filter based on the first life prediction line or the second life prediction line.

### Second Example

The clean air equipment according to first example, the start point of the first life prediction line and the end point of the second life prediction line coincide with each other, so that the start point of the second life prediction line and the end point of the first life prediction line coincide with each other.

### Third Example

The clean air equipment according to second example, the first life prediction line and the second life prediction line are corrected so that they overlap each other.

### Forth Example

The clean air equipment according to third example, the filter is managed according to the corrected life prediction line and the value of the wind speed sensor.

### Fifth Example

The clean air equipment according to first example, the correction measurement is performed at the time of the first periodic inspection.

### Sixth Example

The clean air equipment according to first example, the clean air equipment is a ceiling FFU, and the wind speed sensor and the differential pressure sensor are provided only in a part of the ceiling FFU installed on the same ceiling.

### Seventh Example

The clean air equipment according to forth example, having first warning value associated with the first life prediction line or the second life prediction line, and warning is issued when the value of the wind speed sensor is lower than the first warning value.

### Eighth Example

The clean air equipment according to seven example, having second warning value associated with the first life prediction line or the second life prediction line, and alarm is issued when the value of the wind speed sensor is lower than the second warning value.

### Ninth Example

The clean air equipment according to eighth example, request the arrangement of replacement parts at the time of the alarm notification.

### Tenth Example

The clean air equipment according to first example, having a display function of either the first life prediction line, the second life prediction line, or the corrected life prediction line.

### Eleventh Example

The clean air equipment according to first example, when the amount of deviation from the corrected life prediction line of one of the differential pressure sensor data or the wind speed sensor data is significantly different from the amount of deviation from the corrected life prediction line of the data of the other sensor, it is judged to be anormal data.

### Twelfth Example

The clean air equipment according to first example, when it is determined that the anormal data is used, propose checking or correction of the state of use or installation.

### Thirteenth Example

The clean air system having clean air equipment according to first example, the data of the wind speed sensor and the data of the differential pressure sensor are transmitted to an arithmetic device separate from the clean air equipment via a communication line or electrical wiring.

### Fourteenth Example

The clean air system according to thirteenth example, wherein the arithmetic device collects information of wind speed sensor and differential pressure sensor from a plurality of the clean air equipment, and places a collective order, arrangement, or collective production of the filters.

### Fifteenth Example

The clean air system according to fourteenth example, the arithmetic device collects information of wind speed sensor and differential pressure sensor from a plurality of the clean air equipment, and reduces the inventory amount of the filter.

What is claimed is:

1. A clean air equipment having a filter, wherein:
a wind speed sensor that measures the air speed after passing through the filter;
a differential pressure sensor that measures the pressure difference before and after the filter;
forming the second life prediction line so as to fit a changing rate of the first life prediction line obtained from the initial value of either one of the wind speed sensor or the differential pressure sensor and the value at the time of correction measurement with a changing rate of the second life prediction line obtained from another one of the wind speed sensor or the differential pressure sensor,
managing the filter based on the first life prediction line or the second life prediction line.

2. The clean air equipment according to claim 1, wherein the start point of the first life prediction line and the end point of the second life prediction line coincide with each other, so that the start point of the second life prediction line and the end point of the first life prediction line coincide with each other.

3. The clean air equipment according to claim 2, wherein the first life prediction line and the second life prediction line are corrected so that they overlap each other.

4. The clean air equipment according to claim 3, wherein the filter is managed according to the corrected life prediction line and the value of the wind speed sensor.

5. The clean air equipment according to claim 1, wherein the correction measurement is performed at the time of the first periodic inspection.

6. The clean air equipment according to claim 1, wherein the clean air equipment is a ceiling FFU, and the wind speed sensor and the differential pressure sensor are provided only in a part of the ceiling FFU installed on the same ceiling.

7. The clean air equipment according to claim 4, wherein having first warning value associated with the first life prediction line or the second life prediction line, and warning is issued when the value of the wind speed sensor is lower than the first warning value.

8. The clean air equipment according to claim 7, wherein having second warning value associated with the first life prediction line or the second life prediction line, and alarm is issued when the value of the wind speed sensor is lower than the second warning value.

9. The clean air equipment according to claim 8, wherein request the arrangement of replacement parts at the time of the alarm notification.

10. The clean air equipment according to claim 1, wherein having a display function of either the first life prediction line, the second life prediction line, or the corrected life prediction line.

11. The clean air equipment according to claim 1, wherein when the amount of deviation from the corrected life prediction line of one of the differential pressure sensor data or the wind speed sensor data is significantly different from the amount of deviation from the corrected life prediction line of the data of the other sensor, it is judged to be anormal data.

12. The clean air equipment according to claim 1, wherein when it is determined that the anormal data is used, propose checking or correction of the state of use or installation.

13. The clean air system having clean air equipment according to claim 1, wherein the data of the wind speed sensor and the data of the differential pressure sensor are transmitted to an arithmetic device separate from the clean air equipment via a communication line or electrical wiring.

14. The clean air system according to claim 13, wherein the arithmetic device collects information of wind speed sensor and differential pressure sensor from a plurality of the clean air equipment, and places a collective order, arrangement, or collective production of the filters.

15. The clean air system according to claim 14, wherein the arithmetic device collects information of wind speed sensor and differential pressure sensor from a plurality of the clean air equipment, and reduces the inventory amount of the filter.
